(19) United States
(12) Patent Application Publication
(10) Pub. No.: US 2026/0177732 A1
(43) Pub. Date: Jun. 25, 2026

(54) OPTICAL FILTER ARRANGEMENT

(71) Applicant: ADMESY B.V., Ittervoort (NL)

(72) Inventor: Max COPPERS, Ittervoort (NL)

(21) Appl. No.: 19/127,549

(22) PCT Filed: Oct. 11, 2023
(86) PCT No.: PCT/EP2023/078167

§ 371 Date: May 6, 2025

(30) Foreign Application Priority Data
Dec. 1, 2022 (EP) 22210884.7

(51) Int. Cl. G02B 5/28; G01J 3/28; G01J 3/50; G02B 5/20

(52) U.S. Cl. CPC G02B 5/28; G01J 3/28; G01J 3/50; G02B 5/205

(57) ABSTRACT

An optical filter arrangement comprises an absorption filter having a first filter spectral transmittance and a corrective interference filter provided in an optical path with the absorption filter and having a second filter spectral transmittance. The first filter spectral transmittance has a deviation from a desired filter spectral transmittance for the wavelength range of interest. The second filter spectral transmittance is configured to correct said deviation, such that the combined absorption filter and corrective interference filter together provide a desired filtering of light over the whole wavelength range of interest.

### FIELD OF THE INVENTION

The invention relates to the field of optical light measurement. In particular the invention relates to the use of optical filters in light measurement applications and to the manufacturing of optical filters.

### BACKGROUND

In light measurement devices, such as spectrometers or colorimeters, light sensors are used. The light sensors in practice often comprise a single or a set of photodiodes. When measuring a high-luminance light source, too much light may enter the light measuring light sensor, whereby it fully saturates and the signal which the sensor produces is cut-off at the threshold of the sensor. This effect is called “clipping”. Clipping can make it difficult to perform an accurate colour and spectral measurement. It is for example impossible to determine an exact colourpoint or peak wavelength based on a clipped sensor signal.

For measurements of high-luminance light sources it is known to provide a neutral density filter (ND filter) in the optical path between the light source and the light sensors. The purpose of a neutral density filter in the optical path is to reduce the intensity of all wavelengths within a certain wavelength range equally, such that a minimal undesirable influence results on the accuracy of the measurements.

Alternatively, in some cases one wants to block unwanted light from specific wavelengths, such as for example in bandpass filters.

Generally, an optical filter is made according to one of two types. The first type are reflective filters or interference filters which reflect the unwanted light and allow the wanted light to pass. The second type are absorption filters, which absorb the unwanted light and allow the wanted light to pass. Depending on the chosen filter technology these filters have potential disadvantages when making a neutral density filter, or any other filter which has for a purpose to decrease the amount of light uniformly across the whole wavelength range or a specific part of the wavelength range.

Reflective or interference neutral density filters can be made accurately such that they can match the spectrum almost perfectly, i.e. light across the full wavelength range is decreased with the same proportion or percentage or the specific part of the spectrum desired can be selected very accurately. However, a fully reflective neutral density filter causes a lot of internal light reflections in the measurement device, which can cause straylight interfering with the accuracy of the measurement. Straylight in this context is defined as light which unintentionally ends up on the sensor via internal reflections.

Neutral density absorption filters, even if they are of a relatively good quality, decrease the amount of light non-uniformly across the wavelength range of the filter. In other words, a deviation occurs from a “perfect” spectral match in which light across the full wavelength range is decreased uniformly with the same proportion or percentage. This deviation causes a measurement distortion and negatively influences the accuracy of the measurement, which can lead to visible colour differences in for example display calibration applications.

Also other optical filters, for example bandpass filters or specific wavelengths have the above described disadvantages: The filters of the reflective type can be made accurately, but this is a time-consuming and expensive process. The filters of the absorption type, in particular dyed glass filters are for some applications not suitable, because of a deviation from the desired spectrum.

The invention has for an object to provide an optical filter arrangement, which overcomes the above disadvantages.

### SUMMARY OF THE INVENTION

This object is achieved by an optical filter arrangement for filtering of light comprising:
an absorption filter having a first filter spectral transmittance for a wavelength range of interest;
a corrective interference filter provided in an optical path with the absorption filter and having a second filter spectral transmittance for the wavelength range of interest;
wherein the first filter spectral transmittance has a deviation from a desired filter spectral transmittance for the wavelength range of interest, and
wherein the second filter spectral transmittance is configured to correct said deviation, such that the combined absorption filter and corrective interference filter together provide the desired filtering of light over the wavelength range of interest.

In a specific implementation the invention relates to an optical neutral density filter arrangement for filtering of light comprising:
a neutral density absorption filter having a first filter spectral transmittance for a wavelength range of interest;
a corrective interference filter provided in an optical path with the neutral density absorption filter and having a second filter spectral transmittance for the wavelength range of interest;
wherein the first filter spectral transmittance has a deviation from a perfect uniform filter spectral transmittance for the wavelength range of interest, e.g. the wavelength range for visible light, i.e. a wavelength range from 380 nm to 780 nm, and
wherein the second filter spectral transmittance is configured to correct said deviation, such that the combined neutral density absorption filter and the corrective interference filter together provide a uniform filtering of light over the wavelength range of interest.

Advantageously the invention allows to use a “regular” good quality absorption filter in high end light measurement applications. The influence of the deviation in the spectral behaviour of for example a regular neutral density absorption filter relative to a perfect uniform filter spectral transmittance can be fully eliminated or at least mitigated to an acceptable level by applying a corrective optical filter in the optical path which compensates for the deviation. For other absorption filters, in particular bandpass absorption filters, e.g. absorption filters of a tristimulus filter set, such as an XYZ filter set or an RGB filter set, the same advantage can be achieved. A “regular” good quality absorption filter can be used in high end light measurement applications. The influence of the deviation in the spectral behaviour of the regular absorption filter relative to a desired filter spectral transmittance of the absorption filter can be fully eliminated or at least mitigated to an acceptable level by applying a corrective optical filter in the optical path which compensates for the deviation.

In an embodiment the absorption filter comprises a dyed glass filter. Such dyed glass absorption filters are available in various “colours” amongst which ND filters, and filters of a tristimulus filter set, such as an XYZ filter set or an RGB filter set. For example red, green, and blue filters of an RGB filter set can be regularly available filters which are made economically efficient, and which can be customized for a high end application.

In a preferred embodiment the corrective interference filter is provided as a filter coating on the absorption filter.

Optical filters may have an angular dependency which means that the filtering effect depends on the angle of incidence of the light on the filter. Especially reflective/interference filters may have an angular dependency on the filtering effect. By combining an absorption filter, in particular a dyed glass absorption filter, with an interference filter provided as a coating on the absorption filter, the angular dependency of the filter arrangement can be reduced.

Another embodiment of the optical filter arrangement is conceivable, in which the corrective interference filter is a separate filter which forms an assembly with the main absorption filter. The separate corrective interference filter may be located against the main absorption filter or may be located in the optical path spaced apart from the absorption filter.

The preferred embodiment, in which the corrective interference filter is provided as a filter coating on the absorption filter, provides a single filter element, e.g. an ND filter element, which is advantageously easier to incorporate in an optical (measurement) device. Only one single filter element, e.g. one single ND filter element, has to be placed, which simplifies the assembly of the device. Misalignment of optical filters can become an issue because the filtering effect of optical filters may have an angular dependency. Especially with reflective/interference filters this issue may arise. The risk of misalignment of filters in the filter arrangement is advantageously reduced or eliminated by having one single filter element, e.g. one single ND filter element, according to the preferred embodiment. Furthermore, the risk of straylight caused by the optical filter arrangement, e.g. the optical neutral density filter arrangement, is lower by the use of one single (ND or other) filter element instead of two separate filters.

The interference filter coating can be applied on the absorption filter or on a separate substrate by a sputter deposition process which is a physical vapor deposition (PVD) method of thin film deposition. By using sputter deposition, the filter coating is applied to the entire main absorption filter or substrate. Applying the filter coating by sputter deposition may comprise applying ion beam sputtering. Ion beam sputtering is a method in which an ion beam is directed towards a target. Atoms or molecules are sputtered and directed towards main the absorption filter or the substrate to apply the filter coating.

The coating to be applied can be determined by a software program running on a computer. For example, for a neutral density filter the desired filter spectral behavior is a uniform spectral transmittance over the relevant wavelength range, which is an input parameter for the software. The measured spectral transmittance of the neutral density absorption filter is measured, for example by means of a spectrometer or a monochromator. The measured spectral transmittance is also used as an input parameter of the software. Based on these input parameters and the refractive index of several materials that can be deposited, the software can determine what material layers have to be deposited by the physical deposition process. In other words, the software creates a “recipe” for the coating which is used as an input parameter in the coating device. This is also possible for other filters than neutral density filters, e.g. a bandpass filter, which have a different desired spectral transmittance.

Accordingly, the invention also relates to a method for manufacturing an optical filter arrangement for filtering light, comprising the following steps:
providing an absorption filter;
measuring a first filter spectral transmittance for a wavelength range of interest of said absorption filter;
selecting a desired filter spectral transmittance of the optical filter arrangement for the wavelength range of interest;
determine a deviation of the measured first filter spectral transmittance of the absorption filter relative to the desired filter spectral transmittance;
determine a second filter spectral transmittance for the wavelength range of interest configured to correct said deviation;
providing a corrective interference filter in an optical path with the absorption filter, wherein the corrective interference filter has said second filter spectral transmittance.

In a specific implementation the invention relates to a method for manufacturing an optical neutral density filter arrangement for filtering light, comprising the following steps:
providing a neutral density absorption filter;
measuring a first filter spectral transmittance for a wavelength range of interest of said neutral density absorption filter;
selecting a desired filter spectral transmittance of the optical neutral density filter for the wavelength range of interest;
determine the deviation of the measured first filter spectral transmittance of the neutral density absorption filter relative to the desired filter spectral transmittance;
determine a second filter spectral transmittance for the wavelength range of interest configured to correct said deviation;
providing a corrective interference filter in an optical path with the neutral density absorbance filter, wherein the corrective interference filter has said second filter spectral transmittance.

The correction by the corrective filter is effected by reducing the transmittance at the different wavelengths along the wavelength range of interest. The reduction of the transmittance by the corrective filter, is proportional to the deviation of the measured first filter spectral transmittance of the absorption filter, e.g. the neutral density absorption filter, relative to the desired filter spectral transmittance along the wavelength range. The result of the combination of the first filter spectral transmittance and the second filter spectral transmittance preferably is for an ND filter arrangement a constant filter spectral transmittance. For a bandpass filter, for example, the spectral transmittance has another shape (e.g. a peaked shape).

Preferably, the absorption filter that is provided is a dyed glass filter.

Preferably, the absorption filter is used as a substrate and the corrective interference filter is provided by applying a filter coating directly on the absorption filter.

Preferably the filter coating is provided as a thin film on the absorption filter by a physical vapor deposition process, such as a sputter deposition process.

Instead of coating the interference filter directly on the absorption filter it is also conceivable to provide the interference filter by coating a separate substrate, providing it with the second filter spectral transmittance, and position the separate corrective interference filter in the optical path against or spaced apart from the absorption filter.

The absorption filter used in the method may be a neutral density absorption filter.

The desired filter spectral transmittance for an ND filter arrangement preferably provides a uniform filtering of light over an entire wavelength range it is intended for. This allows to maintain the ratio between the light intensity at the different wavelengths in the wavelength range of interest. In light measurement applications this minimizes the measurement distortion which results in accurate measurements.

The absorption filter used in the method may also be a bandpass absorption filter. The bandpass absorption filter may a filter of a tristimulus filter set, for example the bandpass absorption filter may be a red, green or blue filter of an RGB filter set. The bandpass absorption filter may also be an X, Y or Z absorption filter of an XYZ filter set.

The invention also relates to an optical measurement device comprising an optical filter arrangement as described in the above.

In a particular embodiment of the optical measurement device the optical filter arrangement is a neutral density filter arrangement.

In a further embodiment of the optical measurement device, the optical measurement device comprises one or more light sensitive sensors, such as a photodiode, wherein the neutral density filter arrangement is positioned in an optical path in front of the one or more light sensitive sensors. The corrective interference filter of the arrangement is preferably facing away from the one or more sensors.

The corrective interference filter coating or filter facing away from the sensors eliminates the risk of stray light inside the device caused by reflections by the corrective interference filter coating or filter.

The optical measurement device may be a spectrometer or a colorimeter.

Another aspect of the invention relates to a use of an optical measurement device as described in the above for measuring a light source. In one particular use the optical measurement device is used for measuring a display in a method for calibrating a display. In another particular use the optical measurement device is used for measuring a light source such as a lamp, for example a Deuterium lamp.

The invention will be further elucidated with reference to the drawings:

### BRIEF DESCRIPTION OF THE DRAWINGS

FIG. 1 illustrates schematically a method according to the invention.

FIG. 2 shows an example of a spectrum of a regular neutral density absorption filter and of a coated neutral density filter according to the invention,

FIG. 3 illustrates schematically a physical vapor deposition process applying a corrective optical filter coating on a neutral density absorption filter,

FIG. 4A illustrates in a top view a coated neutral density filter according to the invention,

FIG. 4B illustrates schematically a cross section according to line A-A indicated in FIG. 4B,

FIG. 5 illustrates the effect of clipping of a measurement signal of a light measurement sensor,

FIG. 6 illustrates another embodiment of a neutral density filter arrangement according to the invention,

FIG. 7 illustrates yet another embodiment of a neutral density filter arrangement according to the invention, and

FIG. 8 illustrates schematically a light measurement device according to the invention.

### DETAILED DESCRIPTION

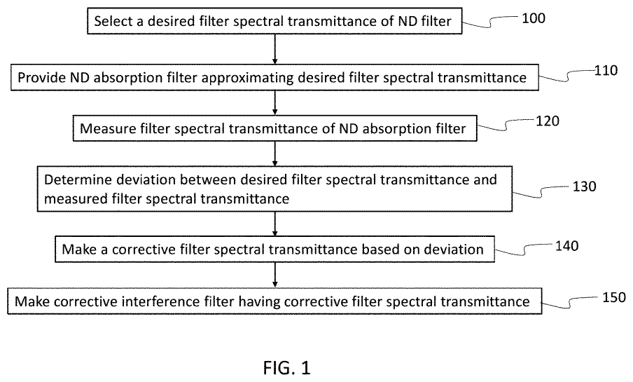

The invention will be explained in the below detailed description using a specific implementation with a neutral density filter (ND filter) arrangement. However, it must be understood that the invention can also be performed in a similar way with other optical filters such as optical bandpass filters with a certain transmittance for example filter having a certain colour, such as red, green, or blue filter of an RGB filter set. Thus where in the below description and in FIG. 1 “ND filter” is mentioned or “ND absorption filter” this can be generalized to “filter” and “absorption filter” with the annotation that for and ND filter the spectral transmittance is preferably constant over the relevant wavelength range (for example visible light, i.e. the wavelength range of 380 nm to 780 nm), whereas for example bandpass filters have a spectral transmittance only over a smaller wavelength range.

For measurements of high-luminance light sources it is known to add a neutral density filter (ND filter) in the optical path. The purpose of a neutral density filter in the optical path is to reduce the intensity of light at all wavelengths within a certain wavelength range equally, such that a minimal influence on the accuracy of the measurement results.

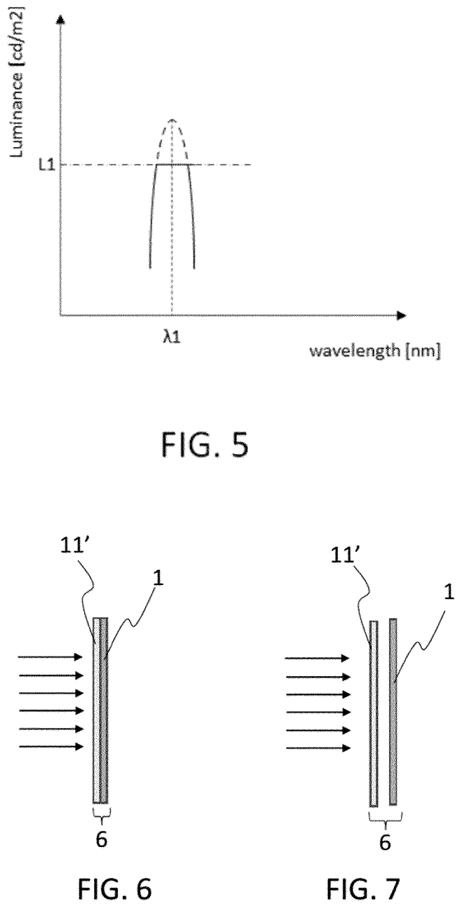

In particular ND filters are used in light measurement devices, such as spectrometers or colorimeters, when applied for measuring high-luminance light sources. Examples of high luminance light sources are light sources in AR/VR displays, some LED/OLED screens or Deuterium light sources. The light measurement device in practice often comprise a set of photodiodes as light measuring sensors. When measuring a high-luminance light source, too much light may enter the light measuring sensor, whereby it fully saturates and the signal the sensor produces is cut-off at the threshold of the sensor. This effect is called “clipping”. Clipping can make it difficult to perform an accurate colour and spectral measurement. In FIG. 5 is for example illustrated how it is impossible to determine an exact colourpoint, i.e. the exact wavelength λ1 of the colourpoint based on a sensor signal which is cut-off or clipped at threshold L1.

Absorption neutral density filters (ND filters), even if they are of a relatively good quality, reduce the amount of light non-uniformly across the wavelength range of the filter. The wavelength range may for example be the wavelength range for visible light, i.e. a range from 380 nm to 780 nm. In FIG. 1 a graph indicated with reference numeral 10 indicates the spectral transmittance of an absorption neutral density filter measured in a wavelength range from 390 nm to 750 nm. This can be measured for example with a spectrometer or a monochromator. Visible is that the filter has a relatively constant light transmittance in a wavelength range between 460 nm and 640 nm. In said range the light transmittance is about 10% and thus the light intensity for those wavelengths is reduced around 90%. In other words the ND absorption filter absorbs about 90% of the incident light which is within the range 460 nm and 640 nm. Still, even within said wavelength range from 460 nm to 640 nm the light transmittance is not constant as is indicated by the “waviness” of the graph 10. Outside said wavelength range, for example for wavelengths from 640 nm to 750, one can see that this particular ND absorption filter has a decreasing filter action, and the light transmittance increases continuously to about 25% at 750 nm. In a range below 460 nm the transmittance decreases continuously from 10% to about 4% for light having a wavelength of 390 nm.

For high-end light or colour measurement applications, a neutral density filter ideally has a constant transmittance or uniform filter spectrum behaviour over the entire wavelength range that is of interest, because in that case the neutral density filter does not distort the measurement of the light or colour along the wavelength range.

However, due to limitations in the production of absorption type neutral density filters a perfectly constant light transmittance over the entire wavelength range of interest cannot be achieved. Thus, if for example the wavelength range of interest is the wavelength range of visible light from 390 nm to 750 nm as is shown in FIG. 1, it is easy to understand that the ND absorption filter with the characteristic indicated by reference numeral 10 deviates from the perfectly constant desired neutral density filter, and thus will distort the measured light intensity across the wavelength range. The distortion in the measured intensity negatively influences the accuracy of the measurement, which can lead to visible colour differences in for example display calibration applications.

As mentioned, in practice a deviation occurs from a “perfect”, constant spectral behaviour in which light across the full wavelength range is decreased uniformly with the same proportion or percentage. The present invention proposes a method by which a neutral density filter arrangement is obtained that approximates the perfect neutral density filter having a constant transmittance over the entire wavelength range of interest.

The proposed method is schematically shown in FIG. 1. In the method a desired filter spectral transmittance is selected that is suitable for the specific application. This method step is indicated by reference numeral 100. For example a “perfect” neutral density filter can be desired having a constant transmittance of 5%.

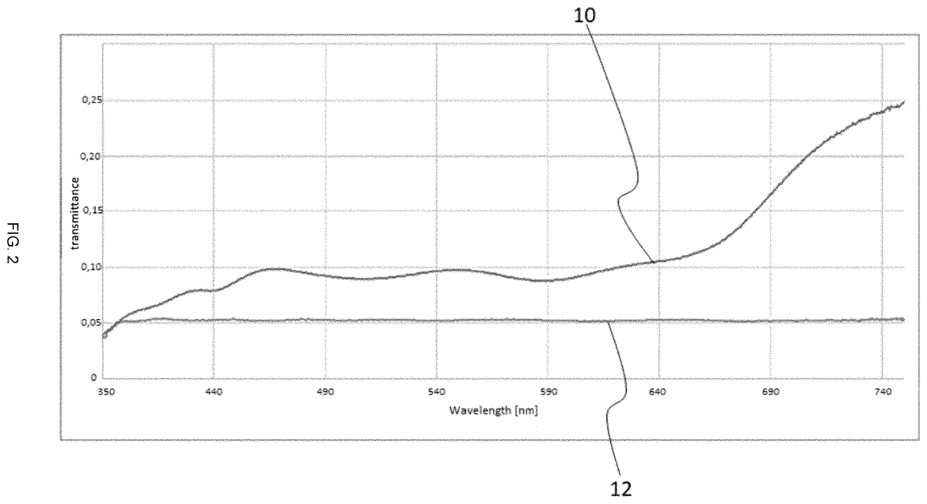

In a following step, indicated by reference numeral 110, a neutral density filter of the absorption type is selected and obtained, which approximately fits best on the “perfect” desired neutral density filter. This may for example be an absorption filter embodied as a dyed glass filter. Thus in the example of a desired transmittance of 5% one would provide a standard ND absorption filter with a transmittance of 10%, which can be acquired off the shelf from a supplier. The ND absorption filter characterized by graph 10 in FIG. 2 is an example of a standard ND absorption filter with a transmittance of 10%.

The spectral transmittance of the individual ND absorption filter that is obtained from the supplier is determined by measurement, e.g. by means of a spectrometer or a monochromator. This step is indicated by reference numeral 120. This measurement results in the graph 10 in FIG. 2. The desired filter spectral transmittance lies below the measured filter spectral transmittance 10 of the neutral density absorbance filter.

In a following step the deviation is calculated between the measured transmittance over the wavelength range (graph 10) and the desired constant spectral transmittance. This step is indicated by reference numeral 130.

The calculated deviation is used to determine a corrective filter spectral transmittance. This step is indicated by reference numeral 140. The corrective filter spectral transmittance is calculated such that the superposition of the measured spectral transmittance of the original ND absorption filter (graph 10 in FIG. 2) and the corrective filter spectral transmittance results in a filter characteristic having a constant transmittance over the entire wavelength range.

Based on the calculated corrective filter spectral transmittance, a physical corrective filter or auxiliary filter is made. This step is indicated by reference numeral 150. According to the invention this corrective filter is an interference filter, wherein a filter coating is applied on a substrate or directly on the original ND absorption filter.

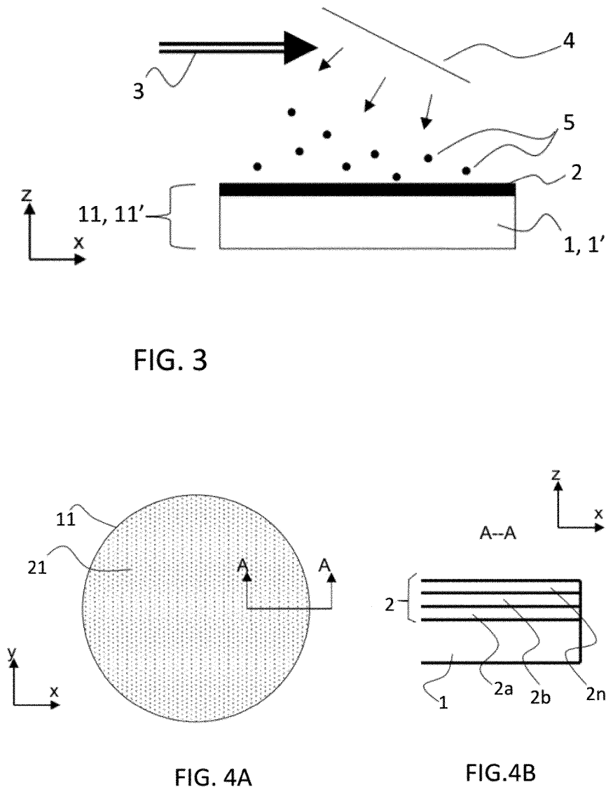

FIG. 3 illustrates, in an embodiment, step 150 of applying an optical filter coating 2 on the original ND absorption filter 1 according to the invention. The ND absorption filter 1, which may be a dyed glass filter, is placed in a physical vapor deposition (PVD) apparatus, in this example an ion beam sputtering (IBS) apparatus. The ion beam sputtering apparatus directs an ion beam 3 onto a target 4. Due to the energy provided by the ion beam 3, a physical reaction in the target 4 occurs, causing the target 4 to release atoms/molecules 5 of a specific material. When the atoms/molecules 5 reach the ND absorption filter 1, the atoms 5 form a thin atomic/molecular layer of material. After having finished one atomic molecular layer, this process is repeated to until the number of atomic/molecular layers results in see FIG. 4B—a coating layer 2a (of the specific material) having a desired layer thickness. Subsequently, this PVD process may be repeated an (n−1)-number of times to create more such coating layers 2b, . . . , 2n until a stack of a plurality of n desired coating layers is obtained. All these n coating layers may be different from one another, but frequently one or more type of layers will be present in a stack several times, like layers 2a and 2d in the example of FIG. 4B. The stack of coating layers 2a, 2b, . . . , 2n forms the optical interferential filter coating 2. The combination of the original ND absorption filter 1 with the optical interferential filter coating 2 on the main surface of the original ND absorption filter 1 forms the corrected neutral density filter 11 which is a possible embodiment of an neutral density filter arrangement according to the invention. In FIG. 4A this corrected neutral density filter 11 is shown having the coated surface 21.

The coated neutral density filter 11 can be measured again by means of a measurement device such as a spectrometer or a monochromator. This measurement is plotted in FIG. 2 as a graph indicated by reference numeral 12. As is clearly visible in FIG. 2 the coating 2 on the original ND absorption filter 1 has modified the filter spectral transmittance 10 to filter spectral transmittance 12 which is almost perfectly corresponding to the desired filter spectrum having a constant transmittance of 5% over the entire wavelength range. If the resulting arrangement of the neutral density absorption filter 1 and the corrective interference filter coating 2 is measured, small insignificant deviations from the perfectly constant filter spectral transmittance can be observed (cf. FIG. 2) which are caused by small coating errors in the corrective filter.

It is noted that instead of coating the interference filter coating 2 directly on the original ND absorption filter 1, it is alternatively envisaged to provide the corrective interferential filter coating 2 on a separate substrate 1′, for example shown in FIG. 3, resulting in a corrective filter 11′ which is positioned in the optical path against (cf. FIG. 6) or spaced apart (cf. FIG. 7) from the original ND absorption filter 1. The arrangements 6 shown in FIGS. 6 and 7, respectively, form thus alternative embodiments of a neutral density filter arrangement according to the invention.

Although the arrangements 6 in the FIGS. 6 and 7 may be used in some applications, it is advantageous to provide the corrective interference filter as a filter coating 2 on the neutral density absorption filter 1, thus obtaining a single ND filter element 11. The single ND filter element 11 is advantageously easier to incorporate in an optical (measurement) device. Only one single ND filter element 11 has to be placed, which simplifies mounting such a single ND filter element in a device. Optical filters may have an angular dependency which means that the filtering effect depends on the angle of incidence of the light on the filter. Especially reflective/interference filters may have an angular dependency on the filtering effect. Alignment of filters is thus an important factor in incorporating them in an optical measuring device. By having one single ND filter element 11 according to the preferred embodiment, issues with mutual alignment of filters in the neutral density filter arrangement are advantageously prevented. Furthermore, the risk of straylight caused by the neutral density filter arrangement is reduced by the use of one single ND filter element 11 instead of two separate filters 11′ and 1. Moreover, the use of a coated neutral density absorbance filter 11 reduces the optical loss, i.e. the intensity of light that is lost, which may be relevant in some applications.

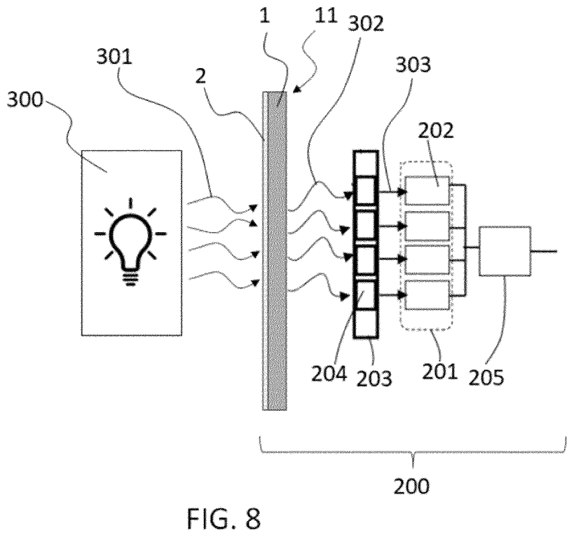

The optical neutral density filter arrangement 11 or 6 according to the invention can be used in an optical measurement device which is used for measuring a high intensity light source. In FIG. 8 a schematic example is shown of a light measurement device 200, that measures a high intensity light source 300. The high intensity light source 300 can for example be a Deuterium light source, a light source in AR/VR displays, or some LED/OLED screen, which may for example be used in tablet computers or smartphones or other display applications.

The light measurement device 200 may for example be a spectrometer which comprises in this example a multichannel sensor 201 comprising a set of photodiodes 202. The set of photodiodes 202 may be arranged in an array, which may be a single row or column, or a two dimensional array, e.g. a square array. In front of the multichannel sensor 201 a filter array 203 is arranged comprising individual band pass filters 204, such that each filter 204 is aligned with one photodiode 202. Each of the filters 204 may be provided with a predetermined spectral behaviour, which allows only light in a relatively narrow wavelength range to be transmitted towards the corresponding photodiode 202 in the multichannel sensor 201. Thus, each photodiode 202 can measure a certain colour component comprised in the incident light 302 on the filter array 203. The photodiodes 202 provide a signal which is fed to a controller 205.

If too much light enters one or more of the individual measuring photodiodes 202, the photodiode 202 fully saturates and the signal the photodiode 202 produces is cut-off at the threshold of the photodiode 202, which is illustrated in FIG. 5. This “clipping” effect reduces the accuracy of the measurement and thus prevents a good measurement of the high-luminance light source 300.

To prevent clipping, the measurement device 200 comprises the corrected neutral density filter 11. The corrected neutral density filter comprises an original ND absorption filter 1 and a corrective filter coating 2 provided directly on the surface of the ND absorption filter 1, which is described in the above with reference to FIGS. 3, 4A and 4B. The corrective filter coating 2 is an interference filter coating. The corrective neutral density filter 11 is positioned in front of the filter array 203, such that it reduces the luminance before it goes through the filters 204 of the filter array 203. Preferably the neutral density filter 11 is arranged such in the measurement device 200 that the interference filter coating 2 is facing the light source 300, such that reflections by the interference filter coating 2 do not occur at the side where the light measuring sensors 202 are located. It is noted though that in many applications it is not essential on which side the corrective coating 2 is located.

The incident light 301 on the neutral density filter 11, which comes from the high luminance light source 300, is filtered by the neutral density filter 11, such that the luminance is reduced considerably, for example to 5% of the original luminance, all across the wavelength range of interest of the light 301. The intensity of the incident light 303 on the respective photodiodes is reduced equally over all photodiodes 202 this way, whereby the colour components of the light 301 are measured by the multichannel sensor 201 without the risk of saturation of any of the photodiodes 202 and without a distortion of the relation between the measurements by the different channels (different colours) of the multichannel sensor 201.

The implementation of the invention for making the neutral density filters can be summarised by the following clauses:

1. Optical neutral density filter arrangement (11; 6) for filtering of light comprising:
a neutral density absorption filter (1) having a first filter spectral transmittance (10) for a wavelength range of interest;
a corrective interference filter (2; 11′) provided in an optical path with the neutral density absorption filter (1) and having a second filter spectral transmittance for the wavelength range of interest;
wherein the first filter spectral transmittance has a deviation from a perfect uniform filter spectral transmittance for the wavelength range of interest, and
wherein the second filter spectral transmittance is configured to correct said deviation, such that the combined neutral density absorption filter (1) and corrective interference filter (2, 11′) together provide a uniform filtering of light over the wavelength range of interest.

2. Optical neutral density filter arrangement according to clause 1, wherein the corrective interference filter is a filter coating (2) provided on the neutral density absorption filter (1).

3. Optical neutral density filter arrangement according to clause 1, wherein the corrective interference filter is a separate filter (11′) which forms an assembly with the neutral density absorption filter (1).

4. Optical neutral density filter arrangement according to clause 3, wherein the corrective interference filter (11′) is located against the neutral density absorption filter (1).

5. Optical neutral density filter arrangement according to clause 3, wherein the corrective interference filter (11′) is located in the optical path spaced apart from the neutral density absorption filter (1).

6. Optical neutral density filter arrangement according to any one of the preceding clauses, wherein the wavelength range of interest is from 380 nm to 780 nm.

7. Optical measurement device comprising an optical neutral density filter arrangement according to any one of the preceding clauses.

8. Optical measurement device according to clause 7, wherein the optical measurement device comprises one or more light sensitive sensors, such as a photodiode, the neutral density filter arrangement being positioned in an optical path in front of the one or more light sensitive sensors, wherein the corrective interference filter (2, 11′) of the arrangement is preferably facing away from the one or more sensors.

9. Optical measurement device according to clause 7 or 8, wherein the optical measurement device is a spectrometer.

10. Optical measurement device according to clause 7 or 8, wherein the optical measurement device is a colorimeter.

11. Method for manufacturing an optical neutral density filter arrangement for filtering of light, comprising the following steps:
providing a neutral density absorption filter (1);
measuring a first filter spectral transmittance (10) for a wavelength range of interest of said neutral density absorption filter (1);
selecting a desired filter spectral transmittance of the optical neutral density filter arrangement for the wavelength range of interest;
determine a deviation of the measured first filter spectral transmittance (10) of the neutral density absorption filter (1) relative to the desired filter spectral transmittance;
determine a second filter spectral transmittance for the wavelength range of interest configured to correct said deviation;
providing a corrective interference filter (2; 11′) in an optical path with the neutral density absorbance filter (1), wherein the corrective interference filter (2; 11′) has said second filter spectral transmittance.

12. Method according to clause 11, wherein the corrective interference filter is provided by applying an interference filter coating (2) directly on the neutral density absorption filter (1).

13. Method according to clause 12, wherein the filter coating (2) is provided as a thin film on the neutral density absorption filter (1) by a physical vapor deposition process, such as a sputter deposition process.

14. Method according to clause 11, wherein the corrective interference filter (11′) is provided by applying an interference filter coating (2) on a separate substrate (1′) and position the corrective interference filter (11′) in the optical path against or spaced apart from the neutral density absorption filter (1).

15. Method according to clause 14, wherein the filter coating is provided as a thin film on the substrate (1′) by a physical vapor deposition process, such as a sputter deposition process.

16. Method according to any one of the clauses 11-15, wherein the desired filter spectral transmittance provides a uniform filtering of light over an entire wavelength range it is intended for.

17. Use of an optical measurement device according to any one of the clauses 7-10 for measuring a light source.

18. Method for calibrating a light emitting display making use of an optical measurement device according to any one of the clauses 7-10.

1. An optical filter arrangement for filtering of light comprising:
an absorption filter having a first filter spectral transmittance for a wavelength range of interest;
a corrective interference filter provided in an optical path with the absorption filter and having a second filter spectral transmittance for the wavelength range of interest;
wherein the first filter spectral transmittance has a deviation from a desired filter spectral transmittance for the wavelength range of interest, and
wherein the second filter spectral transmittance is configured to correct said deviation, such that the combined absorption filter and corrective interference filter together provide the desired filtering of light over the wavelength range of interest.

2. The optical filter arrangement according to claim 1, wherein the absorption filter comprises a dyed glass filter.

3. The optical filter arrangement according to claim 1, wherein the corrective interference filter is a filter coating provided on the absorption filter.

4. The optical filter arrangement according to claim 1, wherein the corrective interference filter is a separate filter which forms an assembly with the absorption filter.

5. The optical filter arrangement according to claim 4, wherein the corrective interference filter is located against the absorption filter.

6. The optical filter arrangement according to claim 4, wherein the corrective interference filter is located in the optical path spaced apart from the absorption filter.

7. The optical filter arrangement according to claim 1, wherein the absorption filter is a neutral density absorption filter and the first filter spectral transmittance has a deviation from a perfect uniform filter spectral transmittance for the wavelength range of interest, and wherein the combined neutral density absorption filter and corrective interference filter together provide a uniform filtering of light over the wavelength range of interest.

8. The optical filter arrangement according to claim 7, wherein the wavelength range of interest is from 380 nm to 780 nm.

9. The optical filter arrangement according to claim 1, wherein the absorption filter is a bandpass absorption filter.

10. The optical filter arrangement according to claim 9, wherein the bandpass absorption filter is a filter of a tristimulus filter set.

11. The optical filter arrangement according to claim 10, wherein the bandpass absorption filter is a red, green or blue filter of an RGB filter set.

12. The optical filter arrangement according to claim 10, wherein the bandpass absorption filter is an X, Y or Z filter of an XYZ filter set.

13. An optical measurement device comprising an optical filter arrangement for filtering of light comprising:
an absorption filter having a first filter spectral transmittance for a wavelength range of interest;
a corrective interference filter provided in an optical path with the absorption filter and having a second filter spectral transmittance for the wavelength range of interest;
wherein the first filter spectral transmittance has a deviation from a desired filter spectral transmittance for the wavelength range of interest, and
wherein the second filter spectral transmittance is configured to correct said deviation, such that the combined absorption filter and corrective interference filter together provide the desired filtering of light over the wavelength range of interest.

14. The optical measurement device according to claim 13, wherein the absorption filter is a neutral density absorption filter and the first filter spectral transmittance has a deviation from a perfect uniform filter spectral transmittance for the wavelength range of interest, and wherein the combined neutral density absorption filter and corrective interference filter together provide a uniform filtering of light over the wavelength range of interest.

15. The optical measurement device according to claim 14, wherein the optical measurement device comprises one or more light sensitive sensors, such as a photodiode, the neutral density filter arrangement being positioned in an optical path in front of the one or more light sensitive sensors, wherein the corrective interference filter of the arrangement is preferably facing away from the one or more sensors.

16. The optical measurement device according to claim 14, wherein the optical measurement device is a spectrometer.

17. The optical measurement device according to claim 13, wherein the optical measurement device is a colorimeter.

18. A method for manufacturing an optical filter arrangement for filtering of light, comprising the following steps:
providing an absorption filter;
measuring a first filter spectral transmittance for a wavelength range of interest of said absorption filter;
selecting a desired filter spectral transmittance of the optical filter arrangement for the wavelength range of interest;
determine a deviation of the measured first filter spectral transmittance of the absorption filter relative to the desired filter spectral transmittance;
determine a second filter spectral transmittance for the wavelength range of interest configured to correct said deviation;
providing a corrective interference filter in an optical path with the absorption filter, wherein the corrective interference filter has said second filter spectral transmittance.

19. The method according to claim 18, wherein the absorption filter is dyed glass filter.

20. The according to claim 18, wherein the absorption filter is used as a substrate and the corrective interference filter is provided by applying an interference filter coating directly on the absorption filter by an ion beam sputter deposition process.

21-23. (canceled)

24. The method according to claim 18, wherein the corrective interference filter is provided by applying an interference filter coating on a separate substrate by an ion beam sputter deposition process and position the corrective interference filter in the optical path against or spaced apart from the absorption filter.

25-34. (canceled)
